(19) United States
(12) Patent Application Publication
(10) Pub. No.: US 2011/0057496 A1
(43) Pub. Date: Mar. 10, 2011

(54) Seats for vehicles

(76) Inventor: Tsan-Ching Wang, Homei (TW)

(21) Appl. No.: 12/585,159

(22) Filed: Sep. 8, 2009

(51) Int. Cl. B60N 2/44; A47C 7/02; A47C 7/00

(52) U.S. Cl. 297/452.1

(57) ABSTRACT

A seat includes a frame and a net which is made of elastic monofilaments. The frame is composed of a first frame and a second frame, wherein the net has a periphery clamped between the first and second frames. The net is mounted from a top of the first frame and the second frame is connected to the first frame from an underside of the first frame. The net of the seat is flexible and provides good ventilation.

### FIELD OF THE INVENTION

The present invention relates to a seat for vehicles and the seat includes a net and a seat frame, the net is securely connected between first frame and second frame so as to provide good ventilation.

### BACKGROUND OF THE INVENTION

The conventional vehicle seats such as bicycle seats or autobike seats, generally includes a seat pad and/or a backrest so that the users sit on the seat pad to operate the vehicle. Most of the seat pads and backrests are made by a foam pad wrapped with a plastic outer layer. The conventional seats can provide basic flexible and comfortable feature, some outer layers are made by air-permeable material or includes gel. Nevertheless, the conventional seats are complained to have less ventilation ability and the users feel not comfortable when setting for a period of time.

Some vehicle seats have holes to enhance the ventilation and some have a layer of gel which is soft and flexible, but most of the conventional seats do not have satisfied ventilation. The seats of autobikes and cars have similar problems although cars have air condition systems to cool the interior temperature in the cars, the outer layer of the seats directly contacts the user's body so that the heat cannot be removed properly.

The present invention intends to provide a vehicle seat which is composed of a net and a frame, the net is securely connected to the frame so as to provide proper ventilation and the net is strong and flexible to support heavy load.

### SUMMARY OF THE INVENTION

The present invention relates to a vehicle seat which comprises a frame and a net, the frame is composed of a first frame and a second frame, and the net has its periphery clamped between the first and second frames.

The primary object of the present invention is to provide a vehicle seat which comprises a net connected to a frame, the net is flexible so as to provide the users a comfortable sitting experience.

Another object of the present invention is to provide a vehicle seat wherein the net includes apertures which provide good ventilation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the first embodiment of the present invention;

FIG. 2 is a partial cross sectional view to show that the net is clamped between the first and second frames of the present invention;

FIG. 3 is a perspective view to show the seat of the present invention used as a seat pad;

FIG. 4 is an exploded view to show second first embodiment of the present invention;

FIG. 5 is a partial cross sectional view to show that the net is clamped between the first and second frames of the second embodiment of the present invention;

FIG. 6 is a perspective view to show the second embodiment of the present invention;

FIG. 7 shows that the present invention is used as a backrest for a bicycle;

FIG. 8 shows that the present invention is used as a seat for a bicycle;

FIG. 9 shows that the present invention is used as a backrest for an autobike, and

FIG. 10 shows that the present invention is used as a seat for a car.

### DETAILED DESCRIPTION OF THE PREFERRED EMBODIMENT

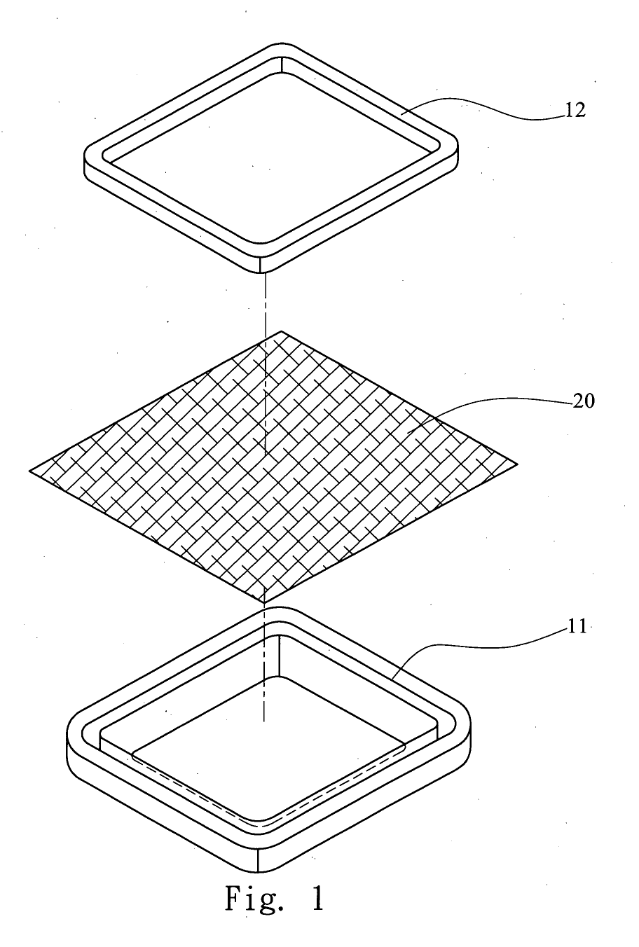

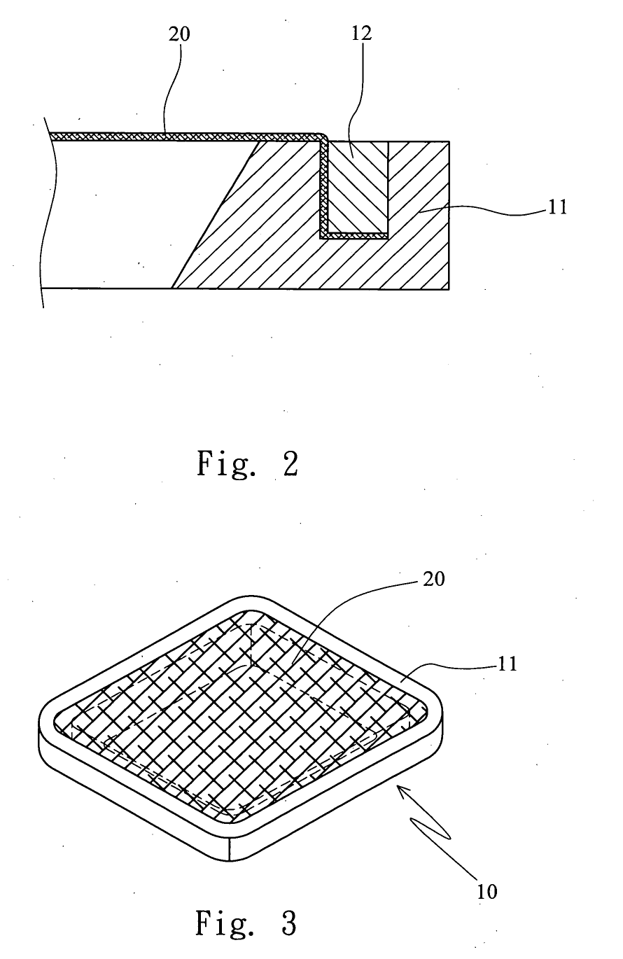

Referring to FIGS. 1 to 3, the first embodiment of the present invention comprises a frame 10 which is composed of a first frame 11 and a second frame 12, and a net 20 has a periphery thereof clamped between the first and second frames 11, 12. The first frame 11 includes a groove which is sized to receive the second frame 12, and the net 20 is clamped in the groove.

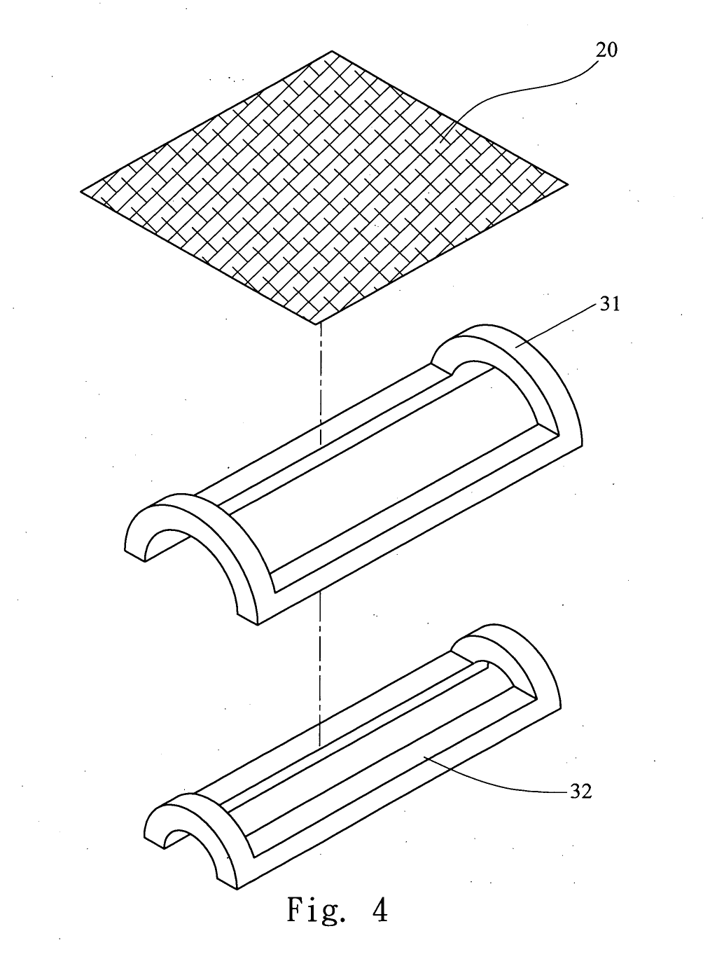

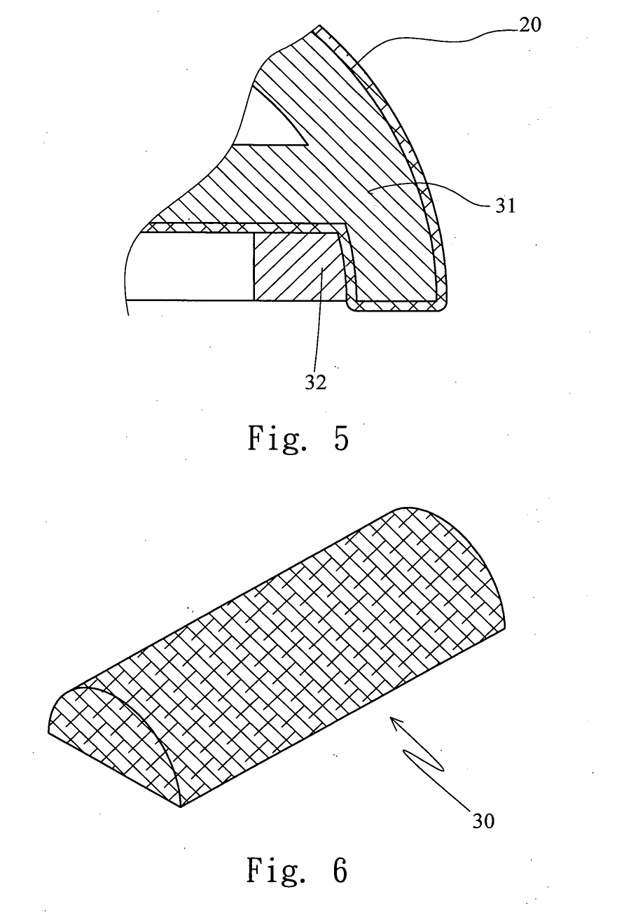

FIGS. 4 to 6 show the second embodiment of the present invention, wherein the frame 30 is composed of a first frame 31 and a second frame 32, and the net 20 is mounted from a top of the first frame 31 and the second frame 32 is connected to the first frame 31 from an underside of the first frame 31. The periphery of the net 20 is clamped between the first and second frames 31, 32.

It is noted that the net 20 is made of elastic monofilaments which are flexile and strong enough to support heavy load. The apertures of the net 20 provide good ventilation.

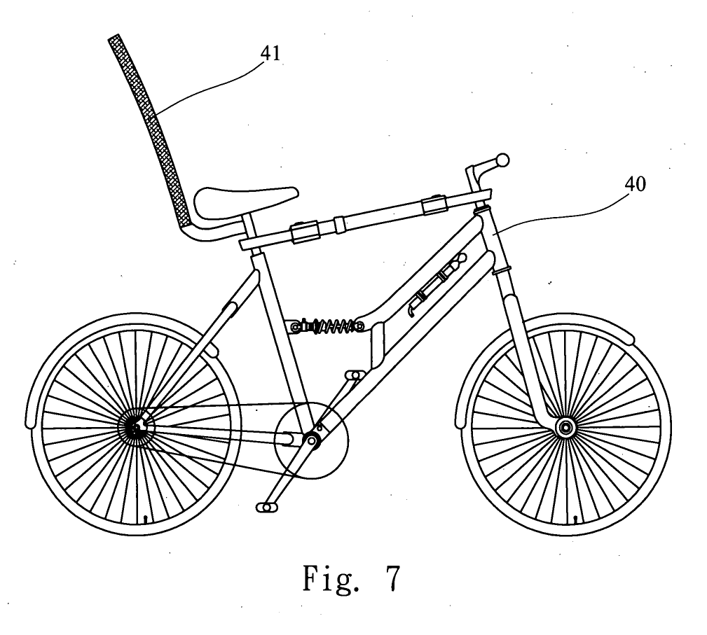

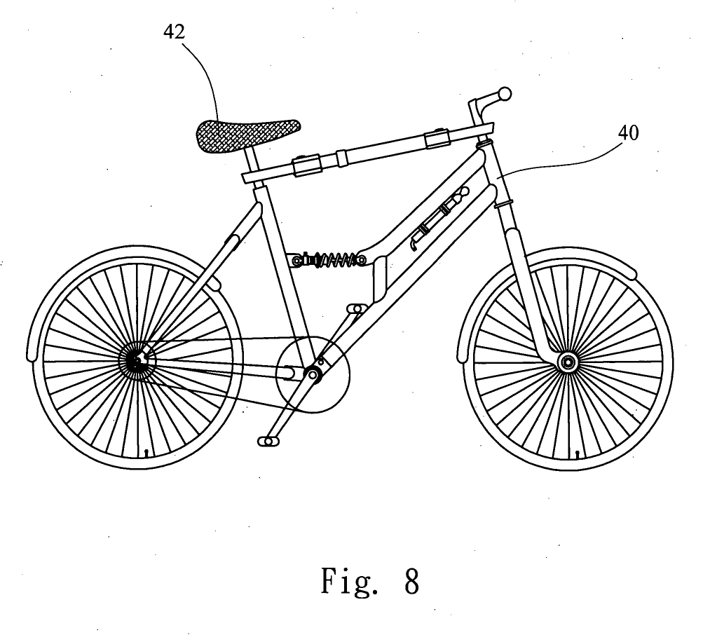

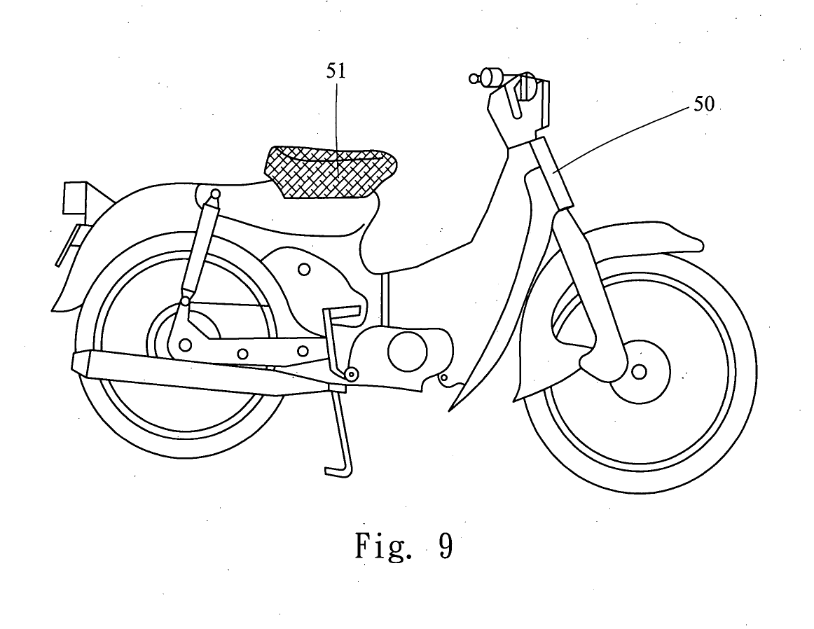

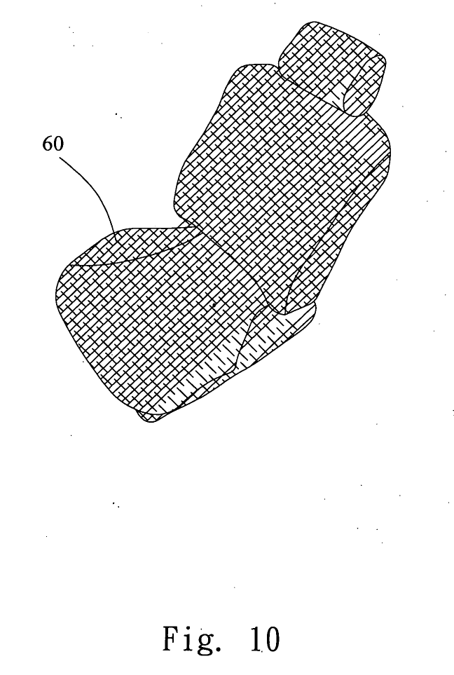

FIG. 7 shows that the present invention is used as the backrest 41 of a bicycle 40, wherein the backrest 41 has one end fixed to the seat post. FIG. 8 shows that the present invention is used as a seat 42 of a bicycle 40, and FIG. 9 shows that the present invention is used as a seat 51 of an autobike 50. FIG. 10 shows that the present invention is used as a car seat 60.

While we have shown and described the embodiment in accordance with the present invention, it should be clear to those skilled in the art that further embodiments may be made without departing from the scope of the present invention.

What is claimed is:

1. A seat comprising:
a frame which is composed of a first frame and a second frame, and
a net having a periphery thereof clamped between the first and second frames.

2. The seat as claimed in claim 1, wherein the net is mounted from a top of the first frame and the second frame is connected to the first frame from an underside of the first frame, the periphery of the net is clamped between the first and second frames.

3. The seat as claimed in claim 1, wherein the net is made of elastic monofilaments.
